(19) United States
(12) Patent Application Publication
(10) Pub. No.: US 2009/0303251 A1
(43) Pub. Date: Dec. 10, 2009

(54) DISPLAYING, PROCESSING AND STORING GEO-LOCATED INFORMATION

(76) Inventors: Andras Balogh, Boulder, CO (US); Tom Blind, Lafayette, CO (US); Tom Churchill, Lafayette, CO (US); Vincent Fiano, Boulder, CO (US)

Correspondence Address: MARSH, FISCHMANN & BREYFOGLE LLP, 8055 East Tufts Avenue, Suite 450, Denver, CO, 80237, US

(21) Appl. No.: 12/136,613

(22) Filed: Jun. 10, 2008

(51) Int. Cl. G09G 5/00

(52) U.S. Cl. 345/632

(57) ABSTRACT

Systems, apparatuses and methods for displaying geo-located imagery are described. The systems may utilize multiple independent quadtree data structures to organize and display geo-located imagery from a variety of sources. A user of the systems described herein may select which geo-located imagery quadtree sets are to be displayed. The user may further select the priority order for the multiple geo-located imagery quadtree sets. The systems may include remote tile servers in communication over the Internet with a local tile server and client at the user's location. The multiple geo-located imagery quadtree sets may include imagery information organized by time of capture, method of capture, and/or source. The imagery may, for example, include photographic imagery, map imagery, and/or charts. The imagery may be supplied by a variety of sources including users and third party imagery providers.

### FIELD OF THE INVENTION

The present invention relates to image display systems in general and to geo-located digital imagery display systems in particular.

### BACKGROUND OF THE INVENTION

Known geo-located imagery systems such as for example Google™ Earth and Microsoft™ Virtual Earth™ enable a user to view geo-located imagery of the Earth's surface (e.g., aerial imagery) displayed on a model of the Earth. The display is typically on a computer monitor and includes a simulated view of a portion of the surface of the Earth from a virtual viewpoint. The user may pan, zoom and rotate the viewpoint. Known geo-located imagery systems may also allow a user to tilt the virtual viewpoint so that the user may select to look straight down from a virtual viewpoint above the Earth's surface, to look parallel to the Earth's surface, or to look at any angle in between. Known geo-located imagery systems may also be capable of rendering the surface of the Earth in three dimensions. For example, mountains and other topography may be rendered in three dimensions.

Known geo-located imagery systems typically use a quadtree data structure where imagery of the entire surface of the Earth is stored in a single quadtree. Accordingly, any point on the Earth's surface may be depicted in a series of quadtree tiles of differing resolutions. However, for a particular point, that point will only be contained in a single image tile at each unique quadtree level (i.e., each unique resolution level).

Known geo-located imagery systems may use a data storage and ordering technique where the best available imagery is incorporated into the data structure at the highest resolution level and all lower resolution tiles are based on the highest resolution level. Accordingly, using this bottom-up structure, at lower resolution levels (e.g., higher virtual viewpoints) the surface of the Earth may appear like a patchwork of differently colored areas. This patchwork effect is due to the data for a particular area having a particular tint or color signature. The tint or color signature may, for example, be due to the imaging technique and/or equipment used to capture the image and/or from seasonal changes. For example, if imagery of one area in a northern U.S. state is captured in winter and imagery from a neighboring area is captured in the summer, the latter may appear green and lush, while the former may appear browner.

Other known geo-located imagery systems may use a data storage and ordering technique where the best available imagery is incorporated into the data structure at the highest few resolution levels of the quadtree and other data sources are used to populate the lower resolution quadtree tiles. For example, aerial imagery, where available, may be used to populate the highest few resolution levels of the quadtree, Landsat imagery may be used to populate the middle resolution levels, and NASA's Blue Marble (BM) imagery may be used to populate the lower resolution levels. Accordingly, such systems show the Earth more uniformly at lower resolution levels when compared to the bottom-up data structure described above. However, when a user zooms in and out in such a system, the displayed quadtrees may include imagery from different sources. For example, a user may zoom out to see a larger portion of the Earth's surface and when the user moves from a resolution level containing aerial imagery to a resolution level containing Landsat imagery, the user may become disoriented or confused because of the sudden change of appearance of the Earth's surface.

Furthermore, when viewing the Earth's surface at an oblique angle, a displayed image may contain different resolution levels. Where these different resolution levels contain imagery from different sources, imagery from different sources may be visible in a single displayed image. For example, aerial image may be displayed in the foreground of a displayed image while Landsat imagery may be displayed in areas further away from the observation point.

Known systems may overlay objects onto a geo-located image. Such objects may include links to additional information (e.g., web pages or separately displayable photographs), borders and roads. Some geo-located imagery systems may contain geo-located imagery panes such as low altitude geo-located aerial photographs. These panes are only accessible from a specific viewing angle that is oblique to the surface of the earth.

### SUMMARY OF THE INVENTION

Embodiments described herein are directed toward geo-located imagery systems that contain a plurality of imagery sets. The plurality of geo-located imagery sets may be in the form of a plurality of independent geo-located quadtree data sets, each containing geo-located imagery. The geo-located imagery may be orthogonal imagery captured from a location substantially orthogonal to the reference ellipsoid of the Earth. For example, such imagery may be captured by an aircraft or satellite equipped with imaging equipment pointed substantially orthogonal to the reference ellipsoid of the Earth (e.g., substantially straight down). A user of the systems described herein may be able to select a geo-located orthogonal imagery set to be displayed from a plurality of available geo-located orthogonal imagery sets for a particular viewpoint.

The multiple geo-located orthogonal imagery sets may each contain a unique set of orthogonal imagery at a variety of resolution levels. A multiple resolution level orthogonal imagery set may include imagery captured at a particular time or during a particular time period. For example, imagery sets may be organized by method of capture, resolution, image source, season, and/or time of day (e.g., including night time imagery). The imagery sets may contain photographic imagery, non-photographic imagery, imagery from maps and/or charts, and/or other imagery that may be geo-located. In this regard, a plurality of multiple resolution level orthogonal imagery sets may each contain unique imagery for a particular portion of the Earth's surface. For example, photographic imagery of a particular portion of the Earth's surface may reside in several different imagery sets such as in an orthogonal imagery set containing Blue Marble imagery, an orthogonal imagery set containing Landsat imagery, an orthogonal imagery set containing 2007 aerial photography imagery, an orthogonal imagery set containing 2006 aerial photography imagery, and so on. The imagery may be supplied by a variety of sources including governmental sources, private parties, geo-located imagery providers, users and third party imagery providers.

A user of the geo-located imagery system may switch between different imagery sets. For example, a user viewing a particular area of the Earth's surface may switch between displaying 2007 aerial imagery, 2006 aerial imagery and 2004 satellite imagery. The user may specify a hierarchy of imagery sets to be displayed wherein if a first priority imagery set is not available for a particular area, the next available imagery set in the imagery hierarchy may be displayed where the first priority imagery set was not available.

The present inventors have realized that existing geo-located imagery systems have several shortfalls. For example, existing systems use a single quadtree data set or multiple quadtrees where each quadtree contains the same photographic imagery for the entire globe. Such existing systems require system administrators to make data inclusion determinations that affect all users of the system. For example, if a particular area is photographed and the new imagery is at a lower resolution than the previous imagery, the system administrators must decide whether the users would prefer more up to date imagery or older imagery with more detail. Other trade-off decisions may be required such as when the newer imagery has increased cloud cover. Additionally, such systems do not easily allow for users to view changes in a particular area over time. Furthermore, such systems, in replacing imagery, may remove from availability information that is valuable to a particular user. For example, a user may wish to view a particular tract of land in a pre-development condition. However, once the imagery is replaced with newer imagery showing land development, the pre-development imagery may be lost to the user. Also, changing imagery due to the replacement of existing imagery with newer imagery may be unwanted by many users. Such unwanted changes may include, for instance, seasonal changes to plants and ground cover, changes to the positions of temporary and/or movable objects (e.g., cars, planes, equipment), and/or changes to development (new construction and/or demolition).

The geo-located imagery systems presented herein do not have these limitations and provide additional benefits over known geo-located imagery systems.

In one aspect, a method for displaying a geo-located image is provided. The method may include presenting a catalog of a plurality of available multiple resolution level orthogonal imagery sets to a user and receiving a first multiple resolution level orthogonal imagery set selection from the user. The method may further include sending a request for a set of image tiles from the first selected multiple resolution level orthogonal imagery set from a computing device to a tile server, receiving the set of image tiles in response to the request, assembling the set of received image tiles into a tile grid, and displaying at least a portion of the tile grid as a geo-located image. At least one of the plurality of available multiple resolution level orthogonal imagery sets may contain different photographic imagery than another of the plurality of available multiple resolution level orthogonal imagery sets.

In an embodiment, the geo-located image may correspond to a portion of the Earth's surface and the plurality of available multiple resolution level orthogonal imagery sets may each contain imagery of that portion of the Earth's surface. In an embodiment, the presenting step may comprise selecting the plurality of available multiple resolution orthogonal imagery sets from a larger plurality of multiple resolution orthogonal imagery sets.

In an embodiment, the computing device may be remote from the tile server. For example, the computing device may communicate with the remote tile server over the Internet. The computing device may, for example, be a personal computer.

In an arrangement, the method may further include receiving a second multiple resolution level orthogonal imagery set selection from the user. In such an arrangement, the first and second multiple resolution level orthogonal imagery set selections may establish a hierarchy of multiple resolution level orthogonal imagery sets. The second request may further request image tiles from the second selected multiple resolution level orthogonal imagery set. The set of received image tiles may contain imagery from the first and second multiple resolution level orthogonal imagery sets. The set of received image tiles may contain imagery from the first and second multiple resolution level orthogonal imagery sets. The imagery from the first and second multiple resolution level orthogonal imagery sets may be displayed according to the hierarchy. In the present arrangement, the imagery from the first and second multiple resolution level orthogonal imagery sets may each contain photographic imagery. The received imagery from the first multiple resolution level orthogonal imagery set may contain photographic imagery captured at a different time than the received imagery from the second multiple resolution level orthogonal imagery set.

In an implementation, the tile grid may define a plurality of tile locations, wherein the received image tiles include a plurality of image tiles corresponding to one of the plurality of tile locations. In this regard, a first one of the image tiles for a particular location may be overlaid on top of a second one of the image tiles for that particular location. In such a display, a portion of the second one may at least partially be visible through the first one.

In an embodiment, the first selected multiple resolution level orthogonal imagery set may comprise a quad-tree data set. In an embodiment, the catalog may be in the form of a list and/or collection of icons.

In another aspect, a method for displaying a geo-located image is provided that may include displaying a first geo-located image. The first geo-located image may be assembled from image tiles from a first imagery set and may correspond to a portion of the Earth's surface. The method may further include generating a catalog of available imagery sets corresponding to the portion of the Earth's surface, receiving an imagery set selection from a user selecting a second imagery set from the catalog, and displaying a second geo-located image. The second geo-located image may be assembled from image tiles from the second imagery set and correspond to the portion of the Earth's surface.

In still another aspect, a method is provided for displaying a geo-located image. The method may include displaying a portion of a first multiple resolution level orthogonal imagery set on a computing device as a first geo-located image and sending a request from the computing device to a remote tile server. The request may include a second multiple resolution level orthogonal imagery set selection different then the first multiple resolution level orthogonal imagery set. The method may include receiving a set of image tiles in response to the request. At least a portion of the set of received image tiles may include imagery from the second multiple resolution level orthogonal imagery set. The method may include displaying at least a portion of the received set of image tiles as a second geo-located image. The second geo-located image may contain imagery from the first and second multiple resolution orthogonal imagery sets.

In an embodiment, the request may include tile location and resolution level information. In an embodiment, the request may include a hierarchical listing of a plurality of multiple resolution level orthogonal imagery set selections. The received set of image tiles may correspond to the hierarchical listing.

In an implementation, the method may include sending a second request to a second remote tile server, receiving a second set of image tiles in response to the second request and displaying at least a portion of the received second set of image tiles as a third geo-located image. The second request may include a third multiple resolution level orthogonal imagery set selection. At least a portion of the second set of received image tiles may include imagery from the third selected multiple resolution level orthogonal imagery set.

In still another aspect, a method for displaying a geo-located image is provided. The method may include sending a request that includes location-based information to a tile server, receiving a set of image tiles in response to the request, receiving a catalog of available multiple resolution level orthogonal imagery sets corresponding to the location-based information, assembling the set of received image tiles into a first tile grid, and displaying at least a portion of the first tile grid as a first geo-located image along with a least a portion of the catalog. At least one of the plurality of available multiple resolution level orthogonal imagery sets may contain different photographic imagery than another of the plurality of available multiple resolution level orthogonal imagery sets In yet another aspect, a method is provided for sending a set of image tiles to a remote computing device. The method may include receiving a request from the remote computing device, obtaining a first set of tiles from a first multiple resolution level orthogonal imagery set, obtaining a second set of tiles from a second multiple resolution level orthogonal imagery set, and sending to the remote computing device the first and second sets of tiles. The request may include a plurality of tile requests. In this regard, the method may be practiced, for example, by a remote tile server that contains a plurality of unique multiple resolution level orthogonal imagery sets.

In another aspect, a method for sending a set of image tiles to a client is provided that may include receiving a request from the client that includes a first orthogonal imagery set selection, determining the availability of the selected first orthogonal imagery set at a geo-location corresponding to the request, and sending a first set of available tiles from the first orthogonal imagery set corresponding to the geo-location to the client.

In an embodiment of the current aspect, the method may further comprise sending tiles from a second orthogonal imagery set to the client, wherein the tiles from the second orthogonal imagery set correspond to areas of the geo-location where image tiles from the first orthogonal imagery set are at least partially unavailable. The second orthogonal imagery set may be chosen based on a hierarchical list of orthogonal imagery sets received from the client. The second orthogonal imagery set may be chosen based on default hierarchical list of orthogonal imagery sets.

In an embodiment, the method may further include sending a second set of tiles to the client. The second set of tiles may contain image portions from the first orthogonal imagery set and image portions from a second orthogonal imagery set. The second set of tiles may be created by overlaying portions of the first orthogonal imagery set over portions of the second orthogonal imagery set. The overlaying may be performed in response to the receiving step.

In an arrangement, the request may further include location-based information. In such an arrangement, the method may further include generating a catalog of available orthogonal imagery sets corresponding to the location-based information. The sending step may further include sending the catalog of available orthogonal imagery sets to the client.

In yet another aspect, a method for sending a set of image tiles to a client is provided. The method may include receiving a request that includes location-based information from the client, determining a default set of map tiles corresponding to the location-based information, generating a catalog of available orthogonal imagery sets corresponding to the location-based information, and sending the default set of map tiles and the catalog of available orthogonal imagery sets to the client.

In another aspect, a computer program product is provided. The computer program product may include a computer usable medium having computer readable program code embodied therein to create a geo-located digital image. The computer readable program code in the computer program product may enable a user to select two or more multiple resolution level orthogonal imagery sets from a plurality of available multiple resolution level orthogonal imagery sets. The computer readable program code may be operable to send a request from the computer program product to a remote tile server. The request may be at least partially based on the selection of the user. The computer readable program code may be operable to receive a set of image tiles in response to the request. At least a portion of the set of received image tiles may include imagery from the two or more selected multiple resolution level orthogonal imagery sets. The computer readable program code may be operable to assemble the set of received image tiles into a tile grid and display at least a portion of the tile grid as a geo-located image.

In another aspect, another computer program product is provided. This computer program product may include a computer usable medium having computer readable program code embodied therein to send a set of image tiles to a client. The computer readable program code in the computer program product may be operable to receive a request from the client. The request may include a first multiple resolution level orthogonal imagery set selection and location-based information. The computer readable program code may be operable to determine the availability of the selected first multiple resolution level orthogonal imagery set at a geo-location corresponding to the request. The computer readable program code may be operable to generate a catalog of available multiple resolution level orthogonal imagery sets corresponding to the location-based information. The computer readable program code may be operable to send a first set of available tiles from the first multiple resolution level orthogonal imagery set corresponding to the geo-location to the client and send the catalog of available multiple resolution level orthogonal imagery sets to the client.

In another aspect, an apparatus is provided for displaying a geo-located image. The apparatus may include a display for displaying a catalog of a plurality of available multiple resolution level orthogonal imagery sets and a user interface for receiving a multiple resolution level orthogonal imagery set selection from the user. The apparatus may further include a processor for generating the catalog based on a user-selected location on the Earth's surface, sending a request to a tile server for a set of image tiles from the selected multiple resolution level orthogonal imagery set, receiving the set of image tiles in response to the request, assembling the set of received image tiles into a tile grid, and generating a geo-located image that may contain at least a portion of the tile grid, wherein the geo-located image is displayed on the display.

In another aspect, an apparatus for sending a set of image tiles to a remote computing device is provided. The apparatus may include a storage device operable to store a plurality of multiple resolution level orthogonal imagery sets and a network interface for communication with the remote computing device. The apparatus may further include a processor for receiving a request from the remote computing device, obtaining a first set of tiles from the storage device in response to the request, obtaining a second set of tiles from the storage device in response to the request, and sending to the remote computing device the first and second sets of tiles. The request may include a plurality of tile requests. The first set of tiles may be obtained from a first multiple resolution level orthogonal imagery set of the plurality of multiple resolution level orthogonal imagery sets. The second set of tiles may be obtained from a second multiple resolution level orthogonal imagery set of the plurality of multiple resolution level orthogonal imagery sets.

In still another aspect, a system for displaying geo-located imagery is provided that may include a client, a remote tile server storing a plurality of multiple resolution level orthogonal imagery sets, and a local tile server for communications between the remote tile server and the client. The client may be operable to generate a display for displaying the geo-located imagery. The client may be operable to control a user interface enabling a user to select for simultaneous display portions of at least two multiple resolution level orthogonal imagery sets of the plurality of multiple resolution level orthogonal imagery sets.

Additional aspects and advantages of the present invention will become apparent to one skilled in the art upon consideration of the further description that follows. It should be understood that the detailed description and specific examples are intended for purposes of illustration only and are not intended to limit the scope of the invention. Furthermore, any of the above arrangements, features and/or embodiments may be combined with any of the above aspects where appropriate.

### BRIEF DESCRIPTION OF THE DRAWINGS

For a more complete understanding of the present invention and further advantages thereof, reference is now made to the following Detailed Description of the Invention taken in conjunction with the accompanying drawings, wherein:

FIGS. 1A through 1D are illustrations of tiles from multiple quadtree imagery sets.

FIG. 2 is an illustration of a display that may be generated by the geo-located imagery system.

FIG. 3 is a schematic diagram of an imagery display where the viewing angle of the display is oblique relative to the surface of the Earth.

FIG. 4 is a schematic diagram of a geo-located imagery system.

FIG. 5 is a schematic diagram of a self-contained geo-located imagery system.

FIG. 6 is a flowchart for a method of updating a display of a geo-located imagery system based on an imagery set selection.

FIG. 7 is a flowchart for a method of updating a display of a geo-located imagery system based on a new location selection.

### DETAILED DESCRIPTION OF THE INVENTION

In the following description, the invention is set forth in the context of apparatuses and methods for displaying, processing and storing geo-located information including geo-located imagery. Embodiments described herein include systems for displaying geo-located images where the displayed images may be selected from and/or created from a plurality of imagery sets.

One method of displaying, processing and storing geo-located imagery is to organize the imagery into a hierarchical data structure such as a quadtree. The quadtree is a multi-level structure with each level representing the same surface area of the Earth with higher (e.g., higher numerical designation) levels representing the surface area with a higher degree of resolution. The imagery contained within each level of the quadtree may be orthogonal imagery captured from a location substantially orthogonal to the reference ellipsoid of the Earth. In one embodiment, the first level of the quadtree represents the entire surface of the Earth and is conceptualized as a “tile”. The second level of the quadtree represents four quadrants of the Earth's surface. For example, the first quadrant may extend from 0 degrees to 180 degrees longitude and from 0 degrees to 90 degrees latitude; the second quadrant may extend from 0 degrees to 180 degrees longitude and from 0 degrees to −90 degrees latitude; the third quadrant may extend from 0 degrees to −180 degrees longitude and from 0 degrees to 90 degrees latitude, and the fourth quadrant may extend from 0 degrees to 180 degrees longitude and from 0 degrees to −90 degrees latitude. The second level of the quadtree can be conceptualized as four smaller tiles. These four smaller tiles are the four quadrants of the tile associated with the first level. It is noted that the portions of the Earth's surface that are represented by these four smaller tiles are not square due to the curvature of the Earth's surface. The third level of the quadtree represents sixteen tiles, four groups of four tiles. Each group of four tiles represents all of the quadrants of one of the tiles represented by the second level of the quadtree. So, for example, if one of the tiles associated with the second level of the quadtree represented the portion of the Earth's surface that includes North America, each of the group of four tiles at the third level that comprise the tile at the second level would represent one of the quadrants of North America.

It should be appreciated that the area of the Earth's surface represented by a tile at a level decreases as the level increases. For example, the area of the Earth's surface represented by a tile at the third level of the quadtree is considerably less than the area of the Earth's surface represented by one of the tiles at the second level of the quadtree. A quadtree representation of the Earth's surface that includes 24 levels provides a tile size at the highest resolution of less than 10 feet by 10 feet.

Embodiments of the geo-located imagery systems described herein may contain a plurality of distinct imagery data sets. The imagery sets may be organized in a plurality of distinct image quadtrees. For example, one of the imagery sets may contain imagery from the Blue Marble imagery set. At lower resolutions, the Blue Marble imagery set may include imagery of the entire Earth. For example at the first level, the Blue Marble imagery set may include a single tile encompassing imagery for the entire Earth. In one implementation, the Blue Marble imagery set may include Blue Marble imagery at each and every level of resolution of the geo-located imagery system.

In another implementation, the Blue Marble imagery set may include Blue Marble imagery for the entire Earth only at lower resolutions (e.g., the first few levels). At higher resolution levels, the Blue Marble imagery set may only include imagery for portions of the Earth's surface where no other imagery set is available. For example, no other data aside from the Blue Marble imagery may be available for portions of ocean surfaces. In this regard, and unlike other Earth imagery systems, the geo-located imagery systems described herein may contain quadtree data sets that are not fully populated with imagery data at every level. Indeed, as described hereinafter, some imagery sets may not be fully populated at any resolution level.

Another one of the imagery sets may contain Landsat imagery. The Landsat imagery set may include Landsat imagery at each and every resolution level. The Landsat imagery may contain imagery of most of the Earth's mid-latitude land surfaces.

As noted, the geo-located imagery system may include separate Blue Marble imagery and Landsat imagery sets. The coverage of the imagery sets may be overlapping. For example, both imagery sets may include imagery of the entire lower 48 states of the United States. The imagery set to be displayed may be automatically selected or user selected. For example, a user using the geo-located imagery system to generate a display covering roughly the entire state of Colorado may choose to view Blue Marble imagery or Landsat imagery.

For a particular portion of the surface of the Earth, the geo-located imagery system may contain additional orthogonal imagery sets. For example, one imagery set may include a composite imagery set comprising the newest available, highest resolution aerial images available over the entire surface of Earth or portion thereof. Such an imagery set may serve as a basic high-resolution imagery set and may be used as a default data set. Another imagery set may comprise a set of aerial imagery captured during a particular time. For example, it may contain aerial imagery captured during a particular day, month or year. In this regard, multiple sets of aerial imagery may be available for a particular location. A user of the geo-located imagery system may be able to select between the multiple sets of available aerial imagery. In this regard, the user of the geo-located imagery system may be able to select between multiple sets of available geo-located orthogonal imagery that each contain unique photographic imagery. This may be useful to, for example, investigate seasonal changes, construction operations, or deforestation. Moreover, multiple imagery sets may be available for a particular day. Such data set may be useful to, for example, study traffic or other movement patterns.

Other imagery sets may be available. For example a plurality of Landsat data sets may be available containing imagery captured at different times or at different resolutions. Other available imagery sets may include images of various types of maps, charts or other documents that may be geo-located. For example, available imagery sets may include images of U.S. Geological Survey topographical maps, street maps, trail maps, aeronautical charts, nautical charts, geological charts, forestation charts, and historical maps.

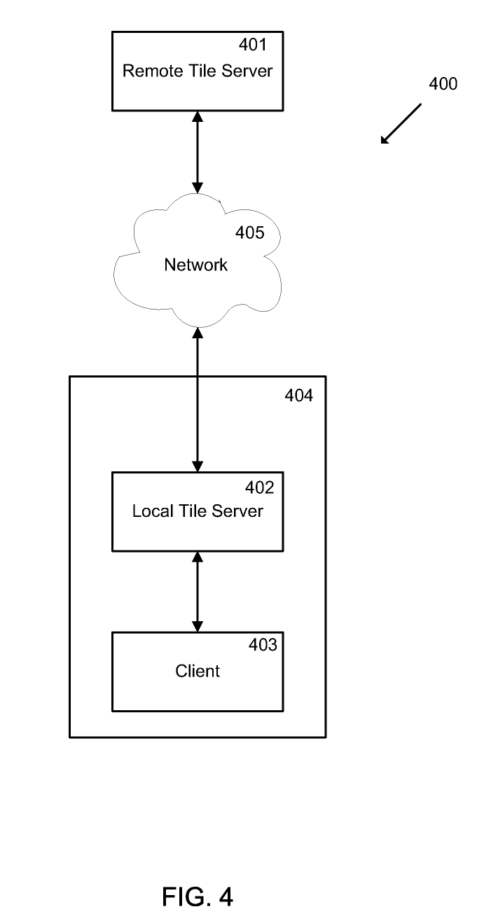

It may be beneficial to briefly describe an exemplary system architecture of a geo-located imagery system. FIG. 4 is a schematic diagram of a geo-located imagery system 400. The geo-located imagery system 400 includes a remote tile server 401 that stores a plurality of imagery sets. The remote tile server 401 may contain multiple photographic imagery sets of a particular area, such as multiple imagery sets each containing aerial imagery of the particular area captured at different times. In the geo-located imagery system 400 of FIG. 4, the remote tile server 401 is interconnected to a network 405. The network 405 may, for example, be the Internet or a local area network (LAN). Multiple remote tile servers 401 may be interconnected to the network 405.

Also connected to the network 405 is a client side computing device 404. The client side computing device 404 may, for example, be a cellular phone or a personal computer connected to the Internet. The client side computing device 404 may include a local tile server 402 that handles communications between a client 403 and the network 405 and other functions. The client 403 may request and render tiles to display geo-located images.

A user at the client side computing device 404 may select an area to be rendered. In response, the client side computing device 404 may request imagery from the remote tile server 401. The remote tile server 401 may send the imagery to the client side computing device 404 in the form of a plurality of image tiles. The client 403 may assemble the tiles into a grid and display the portion of the grid requested by the user. The user may also request that a specific imagery set or a specific imagery hierarchy of image sets be displayed as described below. A more detailed description of the geo-located imagery system 400 and its components is presented below.

One specific example of an available imagery set is an imagery set that may include a plurality of the available national park maps typically handed out to visitors of various national parks throughout the United States. These maps typically contain park boundaries, roads, hiking trails, attractions, and other tourist-related information. The imagery set may include geo-located imagery of the national park maps.

Third party provider and user may also create and make available imagery sets for display by the geo-located imagery system 400. In this regard, the available number of imagery sets from all possible sources may be unlimited. These additional imagery sets may be stored on the remote tile server 401 or they may be stored remote from the remote tile server 401. For example, a third party, such as a demographics company, may offer a pay for use imagery set that includes geo-located graphical representations of demographics. These may be stored on a third party server. In another instance, a user may develop their own imagery set and store it locally where only the user may access the imagery.

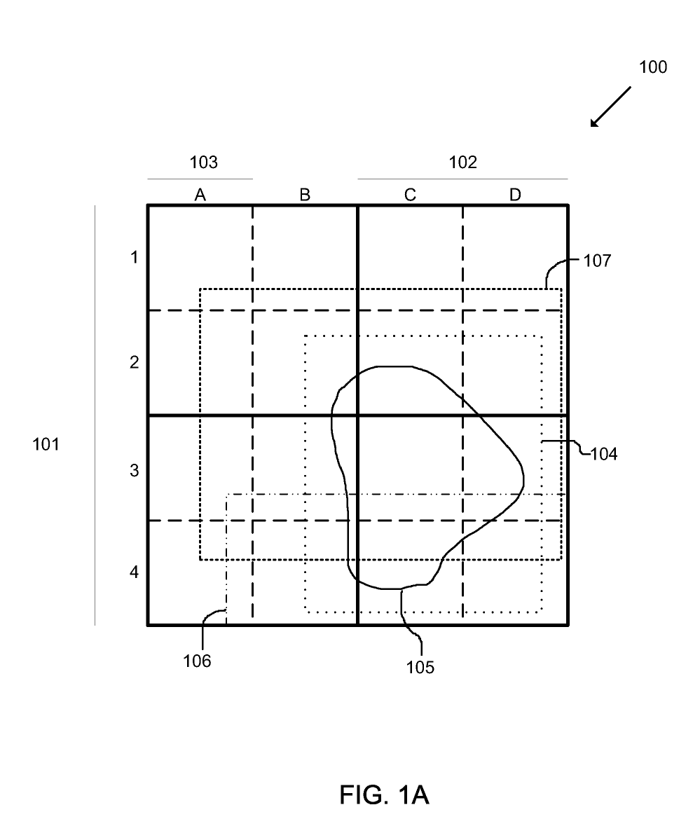

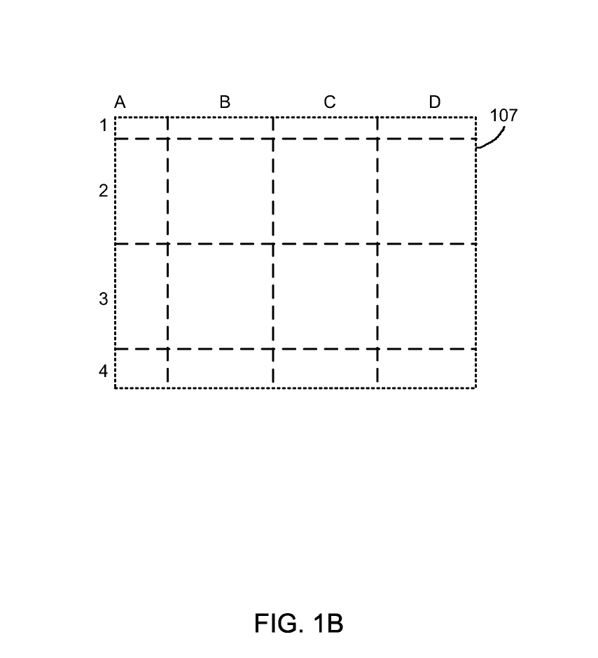

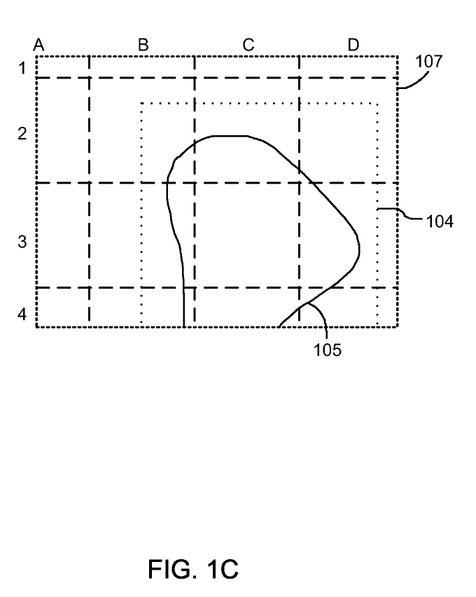

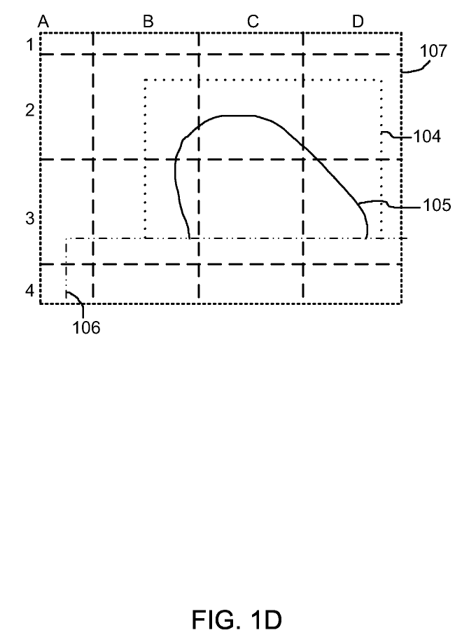

FIG. 1A is a depiction of an exemplary portion of the surface of the Earth 100 and selected corresponding quadtree tiles. The example of FIG. 1 will be used to further describe methods of displaying geo-located images generated from multiple orthogonal imagery sets. Within the portion of the surface of the Earth 100 depicted in FIG. 1, the geo-located imagery system includes four different imagery sets: a basic imagery set that includes the latest available high resolution aerial imagery; a Landsat imagery set; a national park tourist map imagery set; and a to U.S. Geological Survey topographical map imagery set. For the current example, the basic imagery set and the Landsat imagery set each contain image data for the entire portion 100. The national park imagery set only contains image data in the region within the box 104. An exemplary national park boundary 105 is illustrated within the box 104. Finally in the example, the U.S. Geological Survey imagery set only contains image data for the region in the lower right corner of the portion 100 delineated by border 106.

Although FIG. 1A is described herein as including national park and U.S. Geological Survey imagery sets, this is for exemplary purposes only. For example, in other examples, the box 104 may delineate a region where an aerial image produced at a specific time and date is available, or where nighttime imagery is available, or where any other imagery set discussed herein is available. The region delineated by the border 106 may also represent an area where any other imagery set discussed herein is available. Accordingly, line 105 may represent a man-made boundary (e.g., city, zip-code, park, country, etc.) and/or a natural feature (e.g., lake, island, continent, contour lines, etc.).

In FIG. 1A, three different quadtree levels are illustrated: a low resolution level where the entire portion 100 is represented by a single tile with a side length 101; a middle resolution level where the entire portion 100 is represented by four tiles each with a side length 102; and a high resolution level where the entire portion 100 is represented by 16 files each with a side length 103.

When using the geo-located imagery system described herein to view the region 100 at any quadtree level, the user may choose which imagery set or imagery sets to view and may also choose a hierarchy of priority for displaying multiple chosen imagery sets. Various combinations of user viewing choices and methods of generating corresponding displays will now be described with reference to FIGS. 1A through 1D.

First, a user may choose to view the entire portion 100 using a single imagery set. For example, the entire portion 100 may be generated using imagery from the basic imagery set. The viewing area (the area displayed on the user's device) is represented in FIG. 1A by the viewing frame 107. Accordingly, the display may appear as illustrated in FIG. 1B where portions of each of the 16 high-resolution aerial imagery tiles are displayed, including image tiles 3A, 3B and 3C. Each of these 16 image tiles contains only imagery from the basic imagery data set. If the user chooses to view the Landsat imagery set, then each tile would contain only imagery from the Landsat imagery data set.

Alternatively, the user may choose to view the national park imagery set as the highest priority imagery set, with the basic imagery set (or the Landsat imagery set if the Landsat imagery set were chosen as the default imagery set) as the default imagery set in areas where the national park imagery set is not available. FIG. 1C illustrates a display that may be generated using such a hierarchy. Within the viewing frame 107, the area within box 104 contains imagery from the national park imagery set and the area outside of the 104 contains imagery from the basic imagery set. In such a display, individual image tiles within the display may contain imagery from the national park imagery set, the basic imagery set, or a combination of the two. For example, image tile 3A lies outside of the area covered by the national park imagery set and therefore only contains imagery for the basic imagery set. Image tile 3C lies completely within the area covered by the national park imagery set and therefore contains only imagery from the national park imagery set. Image tile 3B covers an area where the national park imagery set is only partially available. Accordingly, image tile 3B may contain national park imagery only in the portion of the image tile 3B where the national park imagery set is available, such as on the right side (as illustrated in FIG. 1C.). In portions of the image tile 3B where the national park imagery set is not available, the image tile 3B may contain imagery from the basic imagery set, such as on the left side of image tile 3B.

As noted earlier, the national park imagery set and the basic imagery set may each be contained in separate imagery sets (e.g., in separate quadtrees). Hybrid image tiles such as image tile 3B which include imagery from the national park imagery set and the basic imagery set may be created using one or more methodologies. A first method of creating a hybrid image tile may include pre-generating composited tiles such as tile 3B. For example, a separate imagery set may be created that contains only imagery in tiles where the national park imagery set is only partially available. This will be referred to as the NP:Basic imagery set. Returning to FIG. 1A, at the lowest illustrated resolution (with side length 101), national park imagery is only partially available so a composited tile would be generated and placed into a NP:Basic imagery set. Similarly, at the middle resolution level, for each of the four tiles the national park imagery is only partially available. Accordingly, composited tiles for each of the four middle resolution tiles would be generated and placed into the NP:Basic imagery set. At the highest level of resolution shown in FIG. 1A, only the tiles 2B, 2C, 2D, 3B, 3D, 4B, 4C, and 4D would be generated and placed into NP:Basic imagery set since they are the only tiles at the high resolution level that partially contain national park imagery. Tile 3C is fully populated by national park imagery and therefore would not be a part of the NP:Basic imagery set. The other tiles contain no national park imagery and therefore would not be a part of the NP:Basic imagery set.

In general, where multiple imagery sets are to be displayed, the imagery sets will be listed herein separated by a colon, in the order of their display priority. These “stacks” will be listed with the highest priority image set listed first. Therefore for example, the NP:Basic:Landsat stack would display national park imagery wherever available, basic imagery where available and where there is no national park imagery available, and Landsat imagery where neither national park imagery nor basic imagery is available.

With such a data structure, a client requesting an image for an area would only need to download one unique tile for each grid location to be displayed. This holds true whether the user selects to view only the basic imagery set, only the national park imagery set, or a hybrid of the basic imagery set and the national park imagery set.

A second method of creating a hybrid image tile may include generating the composited tiles such as tile 3B at the remote tile server on an on-demand basis in response to a request from a client. For example, if a client requests to display imagery as shown in FIG. 1C, the remote tile server may respond to such a request by generating tiles 2B, 2C, 2D, 3B, 3D, 4B, 4C, and 4D by compositing imagery from the national park and basic imagery sets and then sending the composited tiles along with the other appropriate tiles. Using such a method may be beneficial where the particular hybrid image requested by the client is rarely requested. In such situations, it may be more efficient to generate tiles on demand than to store a complete additional image data set for the particular image set combination.

A third method of creating a hybrid image tile may include generating the composited tiles such as tile 3B at the client. For example, if a client requests to display imagery as shown in FIG. 1C, the remote tile server may respond to such a request by sending all tiles for rows 1, 2 and 4 and tiles 3A, 3B and 3D for row 3 from the basic imagery set and sending tiles 2B, 2C, 2D, 3B, 3C, 3D, 4B, 4C and 4D from the national park imagery set. The client than may produce the display of FIG. 1C by overlaying the national park imagery over the basic imagery in the border tiles. The present method may be particularly useful where the imagery sets are stored on different remote tile servers. The present method may also be particularly useful where the client is supplying one of the imagery sets to be composited. For example, a user may generate their own geo-located imagery set and then send a request to the remote tile server for additional imagery data. The client may then composite the user-supplied imagery with the imagery from the remote tile server to produce the display. The above methods may also be used to generate displays with the Landsat imagery set as the default set.

The client may display three or more imagery sets. For example, FIG. 1D illustrates a client display where three different data sets are displayed within the viewing frame 107. The display of FIG. 1D may be produced in response to a user's request to display, in order of priority highest-to-lowest, the U.S. Geological Survey topographical imagery set (USGS), the national parks imagery set and the basic imagery set. Where all of the tiles are pre-generated, the tiles required to build the display of FIG. 1D may be obtained from six different imagery sets as described in the following table:

| Imagery set | Tiles |
|---|---|
| Basic | 1A, 1B, 1C, 1D, 2A |
| NP:Basic | 2B, 2C, 2D |
| USGS:Basic | 3A, 4A |
| USGS:NP:Basic | 3B, 3D |
| USGS:NP | 3C |
| USGS | 4B, 4C, 4D |

If the user were to select the Landsat imagery set instead of the basic imagery set, the imagery sets needed would be similar to the above table with the Landsat imagery set substituted for the basic imagery set.

The display of FIG. 1D may also be produced using either of the other two methods: by generating the composited tiles on demand by the remote tile server or at the client side computing device.

Any combination of the above-described methods of generating a display may be employed to generate a display such as the display of FIG. 1D. For example, the basic imagery set, the national park imagery set and the hybrid NP:Basic imagery set may all be available from a first remote tile server and the U.S. Geological Survey topographical map imagery set may be available form a second remote tile server. To generate the display of FIG. 1D, a client may send a request to the first server for tiles 1A, 1B, 1C, 1D, 2A, 3A and 4A from the basic imagery set, tiles 2B, 2C, 2D, 3B and 3D from the NP:Basic imagery set, and tile 3C from the national park imagery set. The client may also send a request to the second server for tiles 3A, 3B, 3C, 3D, 4A, 4B, 4C and 4D from the U.S. Geological Survey topographical map imagery set. The client's device may then composite the tiles from the first and second remote tile servers to produce the display of FIG. 1D.

In an instance such as illustrated in FIG. 1A where four different imagery data sets are available (basic, Landsat, national park, and USGS), the user may choose to display any one, two, three or all four maps in any appropriate hierarchical order. In instances where the user selects a set of maps that does not contain imagery for the entire viewing frame, the system may fill in the empty areas with a predetermined filler such as a solid color or a pattern to indicate no image data for the areas or the system may select a default imagery set for the empty areas.

As noted, a user at the client side computing device may select a particular imagery hierarchy for a first display of imagery from multiple imagery sets. A user than may select a different set of imagery or may select a different imagery hierarchy for a second display of imagery within the same viewing frame at the same viewing attitude. In such a case, the client may change from the first display to the second display by fading from the first display to the second display. Such an effect may require the entire second display be loaded into the client prior to the fading operation. This may be different than a typical display regeneration, which may be performed by displaying a particular tile of the display as soon as it is downloaded from a remote tile server resulting in a tile-by-tile update of the display.

In an implementation of the geo-located imagery system, the opacity of any particular imagery set being displayed by the client side computing device may be adjustable. To achieve such functionality, each imagery set to be displayed that is to be able to be faded may need to be completely downloaded from the remote tile server. This may require multiple tiles to be downloaded for a particular tile position within the viewing frame. For example, to be able to adjust the opacity of the national park map imagery of FIG. 1C, all sixteen tiles of the basic imagery data set and all nine of the tiles containing imagery from the national park imagery set may need to be downloaded. Accordingly, the ability to adjust the opacity of imagery sets displayed at the client side computing device may require more data to be downloaded to the client side computing device than imagery sets where the opacity is not adjustable.

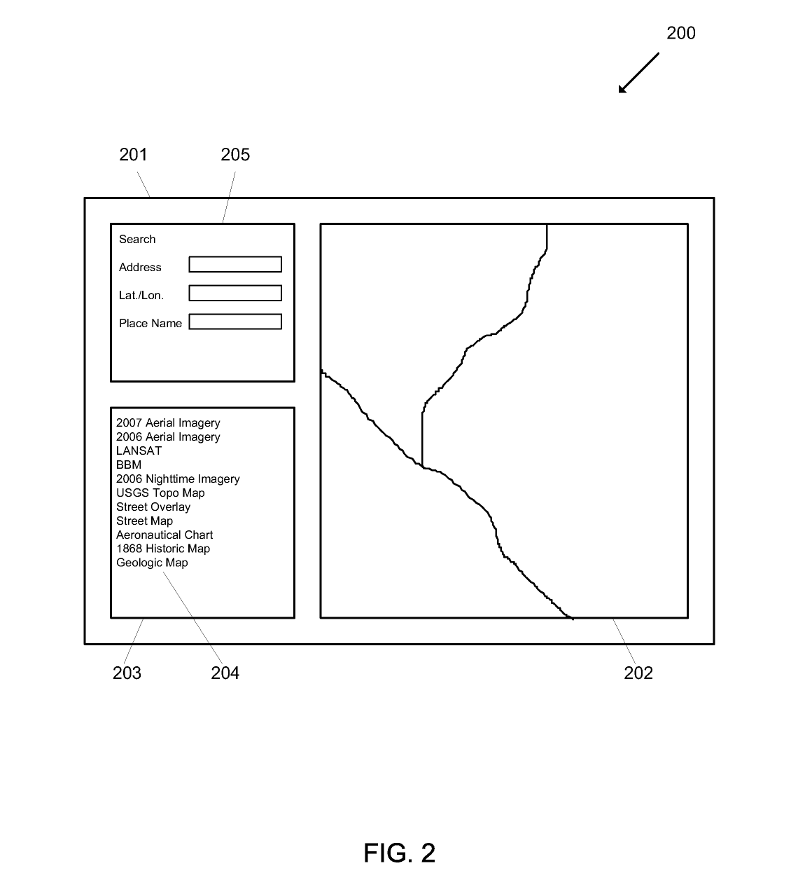

FIG. 2 is an illustration of an exemplary display 200 that may be generated by the geo-located imagery system. The display 200 may be shown on a computer monitor 201. The display 200 and variations thereof may also be shown on other devices such as mobile phones, hand held global positioning system (GPS) devices, automotive GPS systems, personal data assistants (PDAs), portable computers, and any other appropriate devices. The display 200 may include a map window 202. The map window 202 may contain map imagery such as the map imagery within the viewing frame 107 of FIGS. 1A through 1D. The display 200 may include a search window 205 that contains fields where a user may enter data for searching. The display 200 may contain any other appropriate window, such as a window displaying textual or html formatted information such as, for instance, information related to the portion of the Earth's surface shown in the map window 202.

The display 200 may also include a catalog of imagery sets available for the portion of the Earth's surface shown in the map window 202. The catalog may appear as a text listing, a set of icons, and/or in any other appropriate form. The catalog is described below in the context of a listing 204. However, this is for exemplary purposes and the features and uses of the listing 204 may be applied to other appropriate forms of the catalog. The display may also include an imagery set window 203 that contains the listing 204 of imagery sets available for the portion of the Earth's surface shown in the map window 202. The listing 204 may be scale dependent. In this regard, when the map window displays a large portion of the Earth's surface, or a portion of the Earth's surface that correlates to a number of imagery sets beyond a predetermined amount, less than all of the available imagery sets may be displayed. For example, when viewed at the lowest resolution, nearly half of the Earth's surface may be shown in the map window 202. And within that area, the geo-located imagery system may include hundreds, thousands, or more imagery sets. In such a situation, the imagery set listing 204 may contain a subset of the available imagery sets. This subset may be determined by a variety of methods. For example, the subset may be determined by the amount of data available at the particular resolution level. For example, Blue Marble, Landsat, and the basic imagery sets may be listed since these sets cover a significant portion of the globe while the national park imagery set, which would only cover a small portion of the Earth within the United States may not be listed. Other criteria, such as recent viewing by the user, overall popularity, or specific user requests may also be used to determine whether or not a particular imagery set is displayed at a particular resolution level. At higher resolutions, fewer map sets may be available and the listing may be more comprehensive relative to the available imagery sets. Although illustrated as listing only the name of the imagery set, the imagery set window may list additional information regarding each listed imagery set. For example, the listing 204 may include text or icons related to the resolution of the imagery set, the date of creation, the type of imagery, and/or any other appropriate data. The data displayed may be user configurable.

The display 200 may also include a feature to enable a user to search for additional imagery sets. These additional imagery sets may, for example, be user generated or third party imagery sets not present on a main remote tile server 401, but present on some other server or computing device. The third party imagery sets may, for example, be proprietary and hosted by a third party. The third party imagery sets may require a user subscription or payment before access is granted. These additional imagery sets may be rarely used imagery sets resident on the remote tile server 401, but generally not listed in the imagery set listing 204 because, for example, of the infrequency of their use.

A user may select which imagery sets are to be displayed and in what order the imagery sets should be stacked. This may be achieved, by selecting and/or moving (e.g., by clicking on an item with a mouse and/or by dragging and dropping an item) an item within the imagery set listing 204. For example, a user may drag a displayed item to the top of the listing 204 and to the top of the display stack. In this regard, a portion of the listing 204 may be used to show the current stack being displayed. For example, as noted earlier the listing may display available imagery sets. A portion of the available imagery sets may be highlighted or otherwise differentiated to show that those particular imagery sets are currently being displayed.

The display 200 may contain other features and/or controls. These may include positional indicators such as, for example, latitude and longitude listings for the point of view being displayed and/or cursor position, display scale indicators, altitude indicators, and/or place name indictors. Controls may include, but not be limited to, viewpoint movement such as pan, move forward or backward, rotate, and/or tilt. The display may include a listing of available layers that may be superimposed onto the map window. The layers may include any geo-located data and labels including, but not limited to, borders (e.g., national, municipal, postal, etc.), transportation features (roads, railways, paths, etc.), real estate data, geographic features, images, third party data, and/or user placed data.

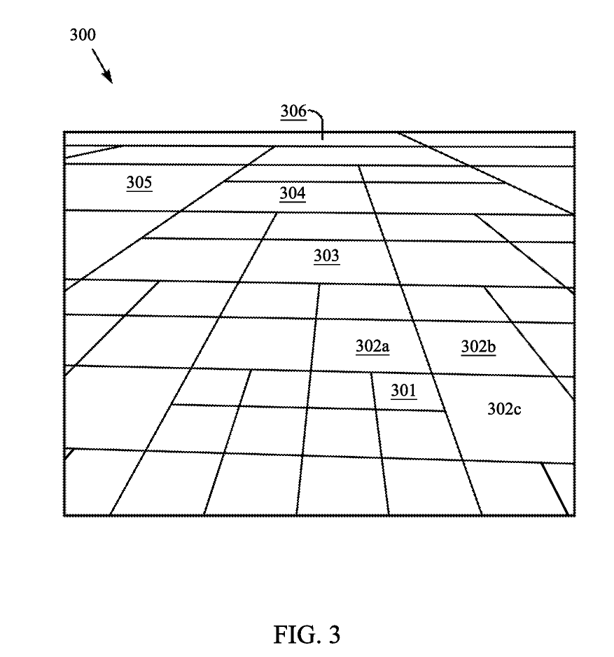

FIG. 3 is an exemplary schematic of an imagery display 300 that may be produced by the geo-located imagery system. The viewpoint of the imagery display 300 is tilted downward relative to the horizon. Accordingly, the tiles in the foreground, such as tile 301 are closer to the virtual viewpoint than the tiles in the background, such as tile 306. Generally, in known systems and in the present geo-located imagery system the resolution of a tile to be displayed is determined by the distance between the viewpoint and the tile location. Accordingly, and as shown in FIG. 3, the tiles closer to the viewpoint are higher resolution than the tiles further away. For example, tile 301 is rendered at a first resolution, while tiles 302a, 302b, and 302c (which are farther away from the virtual viewpoint than tile 301) are rendered at the next lowest resolution (where each tile represents 4 times the area of tile 301). Similarly, tile 303, which is farther away from the viewpoint than tile 302a, is rendered at the next lowest resolution. Tile 304, which is farther away from the viewpoint than tile 303, is rendered at the next lowest resolution. Tile 305, which is farther away from the viewpoint than tile 304, is rendered at the next lowest resolution. Finally, tile 306, the most distant tile within the display, is rendered at the next lowest resolution.

The above display methodology may produce incongruities in some known Earth imaging systems. For example, a known system may contain a single imagery set where, at one resolution the imagery data is derived from a first source, and at a second resolution the imagery data is derived form another source. For instance, the first source may be aerial photography imagery and the second source may be Landsat imagery. When such a system displays the Earth's surface using different sized tiles as shown in FIG. 3, and where the division between different imagery sets coincides with the different tile sizes being displayed, there may be an incongruity between the tiles that include the aerial photography image and the tiles that include the Landsat imagery. For example, if the tile 301 and the other tiles of the same size in the display 300 contain aerial photography imagery and tiles 302a, 302b and 302c and the other tiles of the same size in the display 300 contain Landsat imagery, there will be an incongruity in the imagery along the border between, for example, aerial imagery tile 301 and Landsat imagery tiles 302a, 302b and 302c.

In contrast to the incongruities described above that may be present in prior art systems, geo-located imagery systems described herein may be capable of rendering displays such as display 300 efficiently and without the incongruities. This may be achievable since the geo-located imagery system may contain multiple imagery sets that each contain imagery at a plurality of resolutions. In this regard, to render the display 300, the geo-located imagery system may use tiles that are exclusively from the aerial imagery set and available for each resolution level (including for resolution levels for tiles 301 through 306). The user may alternatively select to view all of the tiles of the display 300 using the Landsat imagery set. Additionally, the display of FIG. 3 may be rendered in three dimensions with topographical features, three-dimensional structures (e.g., buildings), and any other appropriate three-dimensional objects and/or features.

Returning to FIG. 4, the remote tile server 401 may be responsible for compositing tiles from a variety of individual imagery files, each of which can be in any projection (e.g., UTM) and/or color space (e.g., infrared). The imagery files stored on the remote tile server 401 may have complex polygonal shapes, and may be stored in an arbitrary format (e.g., ECW, MRSID, JPEG2K). The remote tile server 401 may also cache the resulting tiles to decrease server-side response time.

The remote tile server 401 may contain a large number of imagery sets and stacked imagery sets. The remote tile server 401 may be at a single centralized location or it may be distributed over many sites. For example, Blue Marble, Landsat, and/or certain aerial imagery may be located on one or more main servers. Some highly requested imagery may be stored on several remote tile servers 401 to minimize access times for users.

The local tile server 402 may handle communication with one or more remote tile servers 401, manage local caching, manage disk access and manage light weight decompression (e.g., of filter compressed or JPEG files). The local tile server 402 may have the ability determine whether a particular server has imagery for a particular tile before making a request. The local tile server 402 may also recognize and reuse identical imagery tiles from a cache of different imagery layers.

The client 403 may be responsible for requesting visible tiles and rendering them. It may also cache tiles in video memory.

The local tile server 402 and client 403 may be resident on the same device, such as a personal computer. The local tile server 402 and client 403 may be separate modules in a single executable file or group of files.

The client side computing device 404 may include a processor for performing functions described herein. For example, the processor may generate the list of available multiple resolution level orthogonal imagery sets, handle communications between the various components of the geo-located imagery system 400, and assemble sets of received image tiles into a tile grids. The processor may further generate geo-located images from the assembled tiles for display.

The remote tile server may include a storage device for storing a plurality of unique multiple resolution level orthogonal imagery sets. The remote tile server may include a processor for performing the remote tile server functions described herein. For example, the processor may be operable to handle communications between the remote tile server 401 and the client side computing device 404. The processor may be operable to access the storage device and obtain requested tiles (e.g., requested tiles from a plurality of unique multiple resolution level orthogonal imagery sets) and send those tiles to the client side computing device 404. In embodiments where requests from client side computing devices 404 include location-based information (e.g., where all of specific tiles needed by the client side computing device 404 are not specified by an exact tile identifier), the processor may be operable to correlate the location based information to a particular set of tiles and forward those tiles to the client side computing device 404. The processor may also be operable to generate a list of available multiple resolution imagery sets based on the location-based information and forward the list to the client side computing device 404.

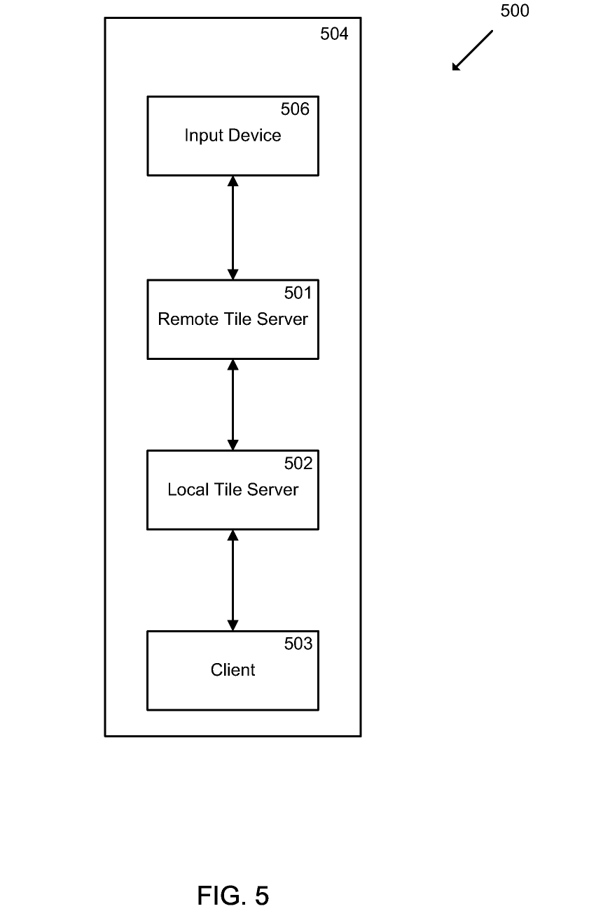

FIG. 5 is a schematic diagram of a self-contained geo-located imagery system 500 capable of producing a user interface and display similar to that of FIG. 2. The system may include a remote tile server 501, a local tile server 502, and a client 503. The geo-located imagery system 500 may perform the same functions as the geo-located imagery system 400 as described with reference to FIG. 4. However, the remote tile server 501 may be directly interconnected to the local tile server 502 as opposed to the network 405 interconnection of FIG. 4. Accordingly, the remote tile server 501, the local tile server 502 and the client 503 may all be contained in a unitary geo-located imagery system 500.

The geo-located imagery system 500 may be contained in a hand-held device such as a GPS receiver, a PDA, portable computer or cellular phone. The geo-located imagery system 500 may be integrated into a vehicular system for use in an automobile, truck, boat, or aircraft. The geo-located imagery system 500 may be entirely self-contained within a housing 504. The geo-located imagery system 500 may be constructed such that one or more of the components of the geo-located imagery system 500 are discrete devices directly interconnected to each other. For example, in an automotive geo-located imagery system 500, the remote tile server 501, local tile server 502 and client 503 may be in a single module while a display device may be mounted in a dashboard and an optional input device 506 may be mounted in a glove compartment.

The input device 506 may be in the form of a connector and associated hardware and software such as a USB and/or firewire connector. The input device 506 may be in the form of a disk drive such as a CD-ROM or DVD drive. The input device 506 may be in the form of a wireless transmitter and/or receiver (e.g., 802.11b wireless LAN, Bluetooth, cellular).

The input device may be used to update imagery data on the remote tile server 501. For example, periodic updates to the imagery database of an automotive geo-located imagery system 500 may be performed by inserting a DVD into the input device 506 of the automotive geo-located imagery system 500. In another example, the input device 506 in the form of a USB connector may be used to upload imagery sets into the geo-located imagery system 500 in the form of a hand held GPS device. Accordingly, geo-located imagery system 500 may have basic imagery sets stored on board and may use the input device 506 to download other image sets. Thus a hybrid system that includes features of both geo-located imagery system 400 and geo-located imagery system 500 may be implemented. The input device 506 may also be used to update software or firmware of the various components of the geo-located imagery system 500.

The geo-located imagery system 500 may contain a processor for performing afore-mentioned functions of the geo-located imagery system 500. The processor may have capabilities and perform functions similar to those described with respect to the processor of the geo-located imagery system 400.

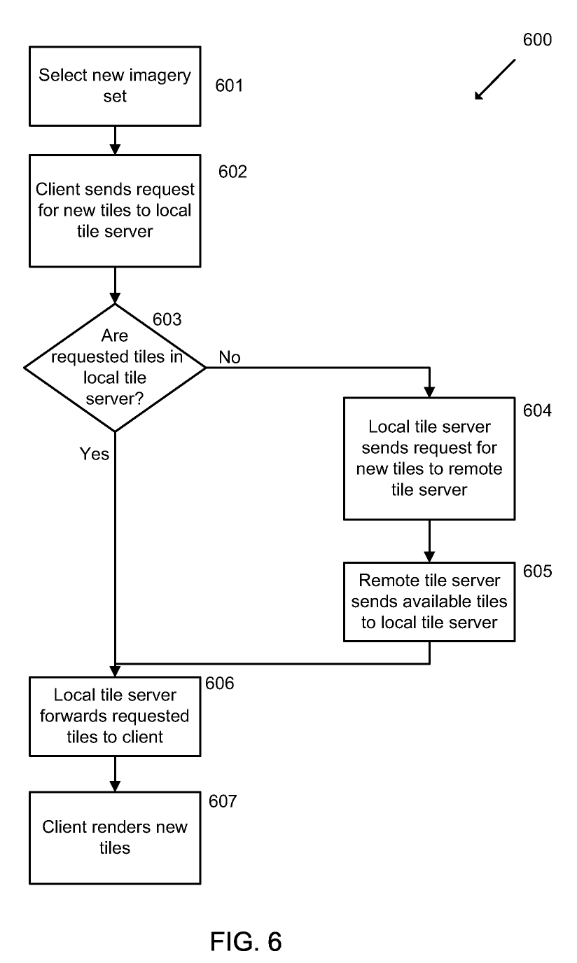

FIG. 6 is a flowchart 600 for a method of updating a display of a geo-located imagery system based on an imagery set selection. The first step in the method may be to select 601 a new imagery set to be displayed by the geo-located imagery system. The selection may be made by a user choosing an available imagery set from a list of available imagery sets. The list of available imagery sets may be a list of imagery sets that contains at least some imagery geo-located to at least a portion of the currently displayed portion of the Earth's surface. The list of available imagery sets may contain a plurality of photographic imagery sets, such as, for example, a plurality of aerial imagery sets for the currently displayed portion of the Earth's surface captured at different times. The list of available imagery sets may, for example, be displayed on a monitor of a personal computer. The user may make the selection by clicking on the name of the desired imagery set or in any other appropriate manner. The selected imagery set may be an imagery set that was not being displayed by the geo-located imagery system at the time of selection, or the selected imagery set may be an imagery set that was being displayed by the geo-located imagery system, but where other imagery sets were displayed over the new imagery (e.g., a stack of imagery sets were being displayed and the selected imagery set was not at the top of the stack). The selection of the imagery set may be a request to move the selected imagery set to a higher level of the stack and/or to place the selected imagery set at the top of the stack. Alternatively, a user may choose to move a selected imagery set to a lower level of the current stack or to remove the selected imagery set from the display altogether. The new imagery set may be a photographic imagery set, such as an imagery set containing aerial imagery. As noted, the new imagery set may be one of several available photographic multiple resolution level orthogonal imagery sets available for the particular area.

After the new imagery set has been selected 601, the next step may be for the client to send 602 a request for new tiles from the selected imagery set to the local tile server. The request to the local tile server may, for example, include the specific tiles to fulfill the request (e.g., by identifying the needed tiles by a unique identifier or identifiers). The request to the local tile server may, for example, include location and imagery set hierarchy information (e.g., leaving the exact required tile information to be determined by the local tile server or other portion of the geo-located imagery system).

At step 603, the local tile server may determine whether or not the requested tiles are presently in the local tile server. If the requested tiles are present, they may be immediately forwarded 606 to the client. If the requested tiles are not present, the local tile server may send 604 the request for the new tiles to the remote tile server. The remote tile server may respond to the request 604 by sending 605 the requested tiles to the local tile server. The communications between the local tile server and remote tile server may occur over a network such as the Internet.

The knowledge of the availability of a specific tile may be resident in the local tile server, the remote tile server, or at some other location. For example, the Blue Marble, Landsat and other popular imagery sets may be resident on the remote tile server(s) and the local tile server may know the availability of the popular imagery sets. In this regard, the local tile server may request the exact tile needed. In another example, the local tile server may not know the availability of an imagery set resident on a third party imagery provider. In this regard, the local tile server may send a request to the remote tile server of the third party imagery provider that includes the requested imagery set, tile location and resolution data. The remote tile server of the third party imagery provider may then determine availability for the imagery set at the particular location and resolution and send the appropriate tiles to the local tile server.

After receiving the tiles sent 605 by the remote tile server, the local tile server may forward 606 the tiles to the client. The client may then render 607 the new tiles to present to the user an updated display that includes the new tiles. The display may also be updated to reflect the newly displayed imagery set and/or the newly selected imagery set hierarchy.

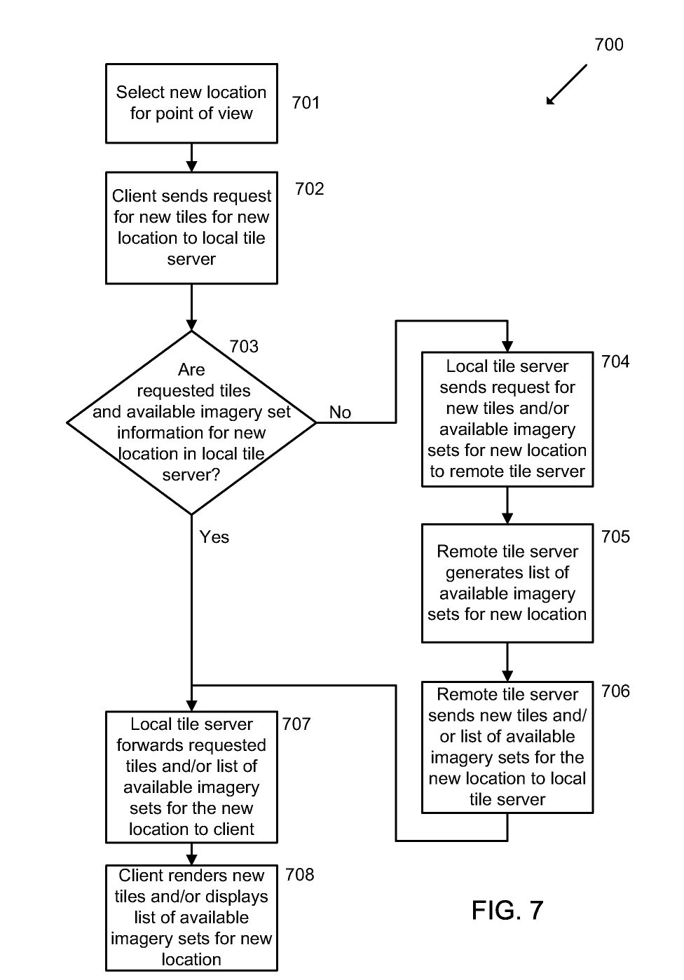

FIG. 7 is a flowchart 700 for a method of updating a display of a geo-located imagery system based on a new location selection. The first step in the method of FIG. 7 may be to select 701 a new location to be displayed by the geo-located imagery system. The new location selection may include any change to a viewpoint within the geo-located imagery system that results in a change to the set of tiles being displayed. Such a change may be a result of user-initiated movement of the viewpoint by panning, translating, tilting and/or rotating a viewpoint. The change may also be initiated by selecting a new viewpoint based on, for example, a user-inputted and/or selected: latitude and longitude, place name, address, and/or any other appropriate method of identifying a location.

After the new location has been selected 701, the next step may be for the client to send 702 a request for new tiles corresponding to the new location to the local tile server. The request to the local tile server may, for example, include the specific tiles to fulfill the request (e.g., by identifying the needed tiles by a unique identifier). The request to the local tile server may, for example, include location and imagery set hierarchy information (e.g., leaving the exact required tile information to be determined by the local tile server or other portion of the geo-located imagery system).

At step 703, the local tile server may determine whether or not the requested tiles and available imagery set information for the new location are presently in the local tile server. If the requested tiles and information are present, they may be immediately forwarded 707 to the client. If the requested tiles and/or information are not present, the local tile server may send 704 the request to the remote tile server. The remote tile server may respond to the request 604 by determining 705 the available imagery sets at the new location and generating a list of available imagery for the new location. Where the request from the local tile server is a request for specific tiles (e.g., where the local server has knowledge of the availability of the tiles and requests them by a unique identifier or identifiers), step 705 may be performed by the local tile server. The remote tile server may then send 706 the requested tiles to the local tile server. The remote tile server may also send a list of the available imagery sets for the new location (e.g., in systems where the entire knowledge of available imagery sets is not present at the local tile server). The communications between the local tile server and remote tile server may occur over a network such as the Internet.

After receiving the tiles and list of the available imagery sets for the new location, the local tile server may forward 707 the tiles to the client. The client may then render 708 the new tiles to present to the user an updated display that reflects the new location. The display may also be updated to reflect the imagery set available for display at the new location.

The methods of FIGS. 6 and 7 may be combined. In this regard, a user may simultaneously select a new imagery set to be displayed and a new viewpoint location. In response, the geo-located imagery system may perform elements of both of the methods to produce a new display showing the newly selected imagery set at the new location along with a new set of available imagery sets for the new location.

The geo-located imagery system may include a computer program product that includes a computer usable medium having computer readable program code embodied thereon. The computer readable program code may be operable to perform any of the client, local tile server and remote tile server functions described above. The computer readable program code may enable the user to select an imagery set from a plurality of available imagery sets and/or select a new location for the viewpoint of the display. The computer readable program code may assemble the tiles into a tile grid for display and display at least a portion of the grid. The computer readable program code may display the available imagery for a particular location. The computer readable program code may display the currently active imagery set hierarchy. The computer readable program code may enable the user to rearrange the imagery set hierarchy and generate a display according to the new hierarchy.

While various embodiments of the present invention have been described in detail, it is apparent that further modifications and adaptations of the invention will occur to those skilled in the art. However, it is to be expressly understood that such modifications and adaptations are within the spirit and scope of the present invention.

1. A method for displaying a geo-located image, said method comprising:
presenting a catalog of a plurality of available multiple resolution level orthogonal imagery sets to a user, wherein at least one of said plurality of available multiple resolution level orthogonal imagery sets contains different photographic imagery than another of said plurality of available multiple resolution level orthogonal imagery sets;
receiving a first multiple resolution level orthogonal imagery set selection from said user;
sending a request for a set of image tiles from said first selected multiple resolution level orthogonal imagery set from a computing device to a tile server;
receiving said set of image tiles in response to said request;
assembling said set of received image tiles into a tile grid; and
displaying at least a portion of said tile grid as a geo-located image.

2. The method of claim 1, wherein said geo-located image corresponds to a portion of the Earth's surface, wherein said plurality of available multiple resolution level orthogonal imagery sets each contain imagery of said portion of the Earth's surface.

3. The method of claim 2, wherein said presenting step comprises selecting said plurality of available multiple resolution orthogonal imagery sets from a larger plurality of multiple resolution orthogonal imagery sets.

4. The method of claim 1, wherein said computing device is remote from said tile server.

5. The method of claim 4, further comprising receiving a second multiple resolution level orthogonal imagery set selection from said user, wherein said first and second multiple resolution level orthogonal imagery set selections establish a hierarchy of multiple resolution level orthogonal imagery sets, wherein said request further requests image tiles from said second selected multiple resolution level orthogonal imagery set, wherein said set of received image tiles contains imagery from said first and second multiple resolution level orthogonal imagery sets.

6. The method of claim 5, wherein said imagery from said first and second multiple resolution level orthogonal imagery sets are displayed according to said hierarchy.

7. The method of claim 5, wherein said imagery from said first and second multiple resolution level orthogonal imagery sets each contain photographic imagery.

8. The method of claim 7, wherein said received imagery from said first multiple resolution level orthogonal imagery set contains photographic imagery captured at a different time than said received imagery from said second multiple resolution level orthogonal imagery set.

9. The method of claim 5, wherein said tile grid defines a plurality of tile locations, wherein said received image tiles include a plurality of image tiles corresponding to one of said plurality of tile locations.

10. The method of claim 9, further comprising overlaying a first one of said plurality of image tiles corresponding to said one of said plurality of tile locations over a second one of said plurality of image tiles corresponding to said one of said plurality of tile locations.

11. The method of claim 10, wherein said displaying step includes displaying said first one of said plurality of image tiles such that said second one of said plurality of image tiles is at least partially visible through said first one of said plurality of image tiles.

12. The method of claim 4, wherein said first selected multiple resolution level orthogonal imagery set comprises a quad-tree data set.

13. The method of claim 4, wherein said catalog is in the form of a list.

14. A method for displaying a geo-located image, said method comprising:
displaying a first geo-located image, wherein said first geo-located image is assembled from image tiles from a first orthogonal imagery set, wherein said first geo-located image corresponds to a portion of the Earth's surface;
generating a catalog of available orthogonal imagery sets based on said portion of the Earth's surface;
receiving an orthogonal imagery set selection from a user selecting a second orthogonal imagery set from said catalog; and
displaying a second geo-located image, wherein said second geo-located image is assembled from image tiles from said second orthogonal imagery set, wherein said second geo-located image corresponds to said portion of the Earth's surface.

15. The method of claim 14, wherein said first and second geo-located images each contain orthogonal photographic imagery, wherein said first geo-located image contains orthogonal photographic imagery captured at a different time than said second geo-located image.

16-21. (canceled)

22. A method for displaying a geo-located image, said method comprising:
sending a request to a tile server, wherein said request includes location-based information;
receiving a set of image tiles in response to said request;
receiving a catalog of available multiple resolution level orthogonal imagery sets corresponding to said location-based information, wherein at least one of said plurality of available multiple resolution level orthogonal imagery sets contains different photographic imagery than another of said plurality of available multiple resolution level orthogonal imagery sets;
assembling said set of received image tiles into a first tile grid;
displaying at least a portion of said first tile grid as a first geo-located image; and
displaying a least a portion of said catalog.

23-33. (canceled)

34. A computer program product, comprising a computer usable medium having computer readable program code embodied therein to create a geo-located digital image, the computer readable program code in said computer program product including:
computer readable program code to enable a user to select two or more multiple resolution level orthogonal imagery sets from a plurality of available multiple resolution level orthogonal imagery sets;
computer readable program code to send a request from said computer program product to a remote tile server, wherein said request is at least partially based on said selection of said user;
computer readable program code to receive a set of image tiles in response to said request, wherein at least a portion of said set of received image tiles includes imagery from said two or more multiple resolution level orthogonal imagery sets;
computer readable program code to assemble said set of received image tiles into a tile grid; and
computer readable program code to display at least a portion of said tile grid as a geo-located image.

35. (canceled)

36. An apparatus for displaying a geo-located image, said apparatus comprising:
a display for displaying a catalog of a plurality of available multiple resolution level orthogonal imagery sets;
a user interface for receiving a multiple resolution level orthogonal imagery set selection from said user; and
a processor for:
generating said catalog based on a user-selected location on the Earth's surface;
sending a request to a tile server for a set of image tiles from said selected multiple resolution level orthogonal imagery set;
receiving said set of image tiles in response to said request;
assembling said set of received image tiles into a tile grid; and
generating a geo-located image that contains at least a portion of said tile grid, wherein said geo-located image is displayed on said display.

37-38. (canceled)

39. The method of claim 14, further including displaying said catalog simultaneously with said displaying a first geo-located image step.

40. The method of claim 22, wherein said displaying of at least a portion of said catalog includes chronologically ordering elements of said catalog.
